(19) United States
(12) Patent Application Publication
(10) Pub. No.: US 2015/0309508 A1
(43) Pub. Date: Oct. 29, 2015

(54) Gyroscope Based Radio Transmitter for Model Vehicles

(71) Applicants: Hasan Kubilay Kara, Columbus, OH (US); Burak Cevik, Cincinnati, OH (US)

(72) Inventors: Burak Cevik, Cincinnati, OH (US); Kubi Kara, Columbus, OH (US)

(21) Appl. No.: 14/263,974

(22) Filed: Apr. 28, 2014

(51) Int. Cl. G05D 1/00; G01C 19/00

(52) U.S. Cl. CPC G05D 1/0016; G01C 19/00

(57) ABSTRACT

Systems and methods for controlling a radio controlled (RC) model vehicle by using a gyroscope based radio transmitter to allow user to have an experience closer to a real life vehicle driving experience. The system consists of a palm size steering wheel, screen display and a pedal. The system is applicable to radio controlled (RC) vehicles such as cars, boats or planes by employing gyroscope technology with coupling the physical orientation of the RC vehicle and the radio transmitter. In one specific embodiment of the invention, the system is demonstrated for an RC model car. In addition, the user settings method to assign specific settings to a specific user is disclosed. Finally, the method for the managing the telemetry information from the vehicle and collecting the user driving session data are also disclosed.

### BACKGROUND OF INVENTION

### Prior Art

U.S. Patents

| Patent Number | Kind Code | Issue Date | Patentee |
|---|---|---|---|
| 5,878,981 | A | 2009 Mar. 9 | Dewey |
| 4,386,914 | A | 1983 Jun. 7 | Dustman |
| 8,600,432 | B2 | 2014 Dec. 3 | Krupnik |
| 6,445,333 | B1 | 2002 Sep. 3 | Tanaka |
| RE42,496 | E1 | 2011 Jun. 28 | Golliher |
| 8,330,583 | B2 | 2012 Dec. 11 | Beard |
| 6,315,667 | B1 | 2001 Nov. 13 | Steinhart |
| 8,649,918 | B2 | 2014 Feb. 11 | Stuckman |
| 8,051,936 | B1 | 2011 Nov. 8 | Hebert |

This invention is related to a system for remotely controlling a radio controlled (RC) vehicle that can be a car or boat, by providing a total new approach against the traditional gun-like shape radio transmitters. In addition to its new design features, it also brings other values that may be helpful to casual radio controlled vehicle user as well as professional competitors.

Radio controlled vehicles continue to get more popular every year. Manufacturers have been introducing the new technologies and features to give users additional control and better handling since 1960s. The typical design for a model car or boat radio control transmitter is gun-like shape that has a trigger for acceleration and brake. There is also a steering wheel not parallel to the user's body to use as a steering mechanism. However, ergonomically it is not a perfect design for users to get used to it. It takes too much practice and time to be able to control the model vehicles decently. Even at the expert level, the capabilities of a human being are limited due to this traditional design.

Prior art shows multiple examples of radio control systems among different types of vehicles but nothing close to real life experience. For example, U.S. Pat. No. 5,878,981 to Dewey discloses a system that a control mechanism apparatus which electromechanically actuates a control board of a radio transmitter. The system has a base frame for providing a stable platform with a seat mounted on the frame. The concept is to emulate the controls found in a cockpit of an actual aircraft. However it is not a solution for a typical model car or boat user in terms of portability and usability. The U.S. Pat. No. 4,386,914 to Dustman also tries to accomplish the same goal as Dewey's solution. By the similar concept, U.S. Pat. No. 8,600,432 to Krupnik describes a method and a system for utilizing a mobile computing device for use in controlling a model vehicle. The system provides various user controls for generating signals that are communicated to a radio transmitter device coupled with the mobile computing device. However, this system also can not be used by a typical model car or boat user easily and practically due to too much technical complexity. Another U.S. Pat. No. 6,445,333 to Tanaka describes a control device for a model aircraft to correct the rudder for a stable operation. However it has no applications for model cars or boats.

Recently by the developments on radio control systems, there were some attempts to make the controllers user-friendlier in terms of ergonomics. However they are not marketable and not feasible for typical users to use. For example, U.S. Pat. No. RE42,496 to Golliher discloses a control system which provides directional control over various real and virtual vehicles and crafts. One drawback that Golliher's design is that additional costs due to this feature are too high that results in uncompetitive retail price for the design to be sold in the market. By the similar intent, U.S. Pat. No. 8,330,583 to Beard describes an invention for controlling a RC device via a secure radio link to capture telemetry information such as speed, RPM or temperature related to the model vehicle. However there is no mention about the inefficient ergonomics of the current radio controllers. Another U.S. Pat. No. 6,315,667 to Steinhart describes a system for remote control of a model airplane by an operator has the following characteristics: an image-capturing device fitted to the model airplane, a device to display the image information to the operator, and a device for remote control of the model airplane. However this application is also not related to the cars or boats. In addition, there are challenges to real-time motion transmitting from the image-capturing device to the operator. In an attempt to emulate the driver seat and steering wheel, a U.S. Pat. No. 8,051,936 to Hebert describes a system for automotive vehicles. The system uses a motor controller to steer the vehicle from a distance by using a transmitter and receiver. However it has drawbacks in terms of safety and practicality in real life situations.

There are some studies with the location and motion sensing technologies in regards to model vehicles. For example U.S. Pat. No. 8,649,918 to Stuckman describes a system that a RC vehicle includes a receiver that is coupled to receive an RF signal from a remote control device. The system compares and processes the two coordinate systems and directs the model vehicle accordingly. But again it is applicable to helicopters and planes.

Although the prior art inventions achieve their individual objectives, they suffer from some drawbacks in respect to cost, compactness and user friendliness.

None of them talks about the common ergonomic problem for the traditional radio control transmitters for model cars and boats. Since the gas and brake trigger and steering knob are not typical user experience when driving a car or boat, it is very hard to learn good enough to be able to control these model vehicles.

None of them talks about the cost effectiveness of the systems. It is critical for the users to be able to afford the new systems. Otherwise the new systems will not be feasible to market

The new system should be a compact design so that an ordinary person should be able to carry it and use it indoors and outdoors.

### ADVANTAGES

Various aspects of the gyroscope based radio control transmitter may have one or more of the following advantages:

One or more aspects provide the advantage that it will provide the best ergonomic design although it may take time to change the common habits of the current users

One or more aspects provides the advantage that it will provide the most cost effective solution which will be comparable to the current cost levels

One or more aspects provide the advantage that it will allow the user to carry it and use it indoors and outdoors easily.

It is therefore one of the objectives of this invention to provide a gyroscope based system that is compact in design, cost effective and very ergonomic for an ordinary human being.

### SUMMARY OF INVENTION

A structure with a steering wheel and a pedal for controlling the radio controlled model car or boat is provided. System is being operated seamlessly by only coupling the radio controller to the receiver mounted to the model vehicle by using the gyroscope modules.

A system for controlling a radio controlled vehicle having a signal receiver and a method to couple the radio transmitter and the signal receiver by the user are provided. The regular steering wheel shaped steering knob together with a gas and brake pedal shaped pedal structure will transmit the direction signal to the RC model car or boat by using the gyroscope data located on the model vehicle.

Said system is also capable to provide the telemetry data such as the speed, the RPM, temperature and battery level from the model vehicle to the operator. An LCD screen will be mounted on the steering wheel base to allow the user to see it constantly.

### BRIEF DESCRIPTION OF DRAWINGS

FIG. 1 is a respective view of a model vehicle and gyroscope based radio transmitter and the pedal.

FIG. 2 is a schematic view of the various components of the steering wheel.

FIG. 3 is a schematic view of the various components of the steering wheel base.

FIG. 4 is a schematic view of the various components of the pedal.

FIG. 5 is a schematic view of the various components of the screen display.

FIG. 6 is a schematic view of the various components of the RC model vehicle.

### DETAILED DESCRIPTION OF THE PREFERRED EMBODIMENT

The detail descriptions to explain the invention is one embodiment of the invention in nature and is not intended to set a limit of possible usage scenarios of the system. Referencing drawings presented, it is referred to the elements of the system being interacted each other to achieve the intended goals. Elements may be directly connected or directly communicating each other.

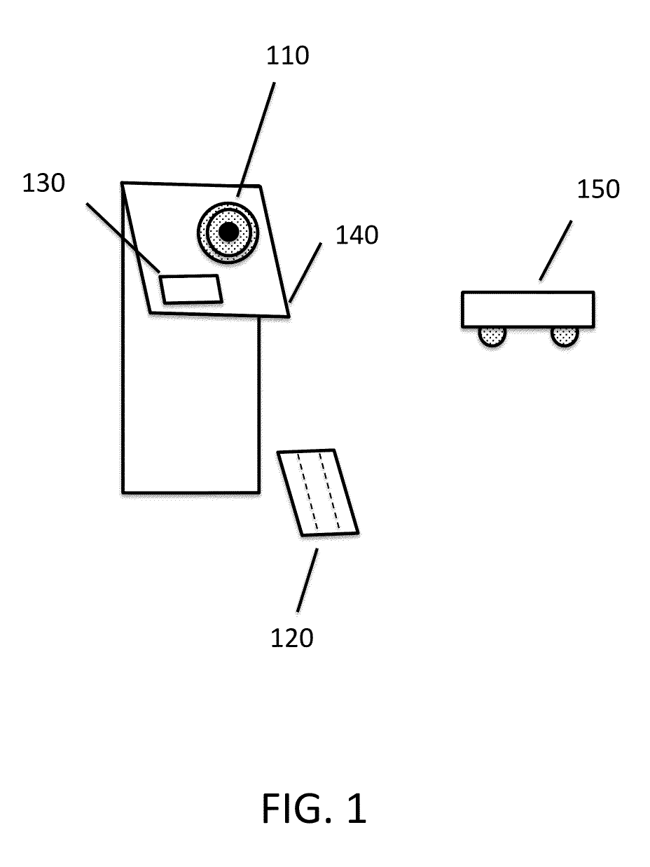

FIG. 1 to FIG. 6 the systems are illustrated for controlling the RC model vehicle having a gyroscope based radio control transmitter consisted of a steering wheel, screen display and a pedal. The steering wheel controls the direction of the RC model vehicle, the pedal controls the acceleration or deceleration of the RC model vehicle and the screen display provides critical telemetry information from the RC model vehicle to the user.

Referencing FIG. 1, the RC model vehicle 150 and gyroscope based radio control transmitter consisted of steering wheel 110, screen display 130 and pedal 120 are presented to show the intended use of the gyroscope based radio control transmitter for RC model cars and boats. However it should be realized that the present invention can be used in other RC model vehicles such as planes, helicopters and other vehicles. In FIG. 1 the model vehicle 150 is a model car and its default radio control receiver is replaced with the embodiment of the invention that is gyroscope transceiver. Typically RC model cars have four wheels of which two in front and two at the rear.

The present invention provides a system that transmits direction signal defined by the user by using the steering wheel knob 110 and also the speed defined by the user by using the pedal 120. The invention provides communication between RC model vehicle 150 and the transmitters 110 and 120 when RC model vehicle 150 connected by radio frequency at 2.4 GHz in this embodiment. This is a benefit of not using a traditional radio transmitter control. This eliminates the need to put a lot of time to learn how to get used to the unnatural driving style that is much different than driving a car traditionally.

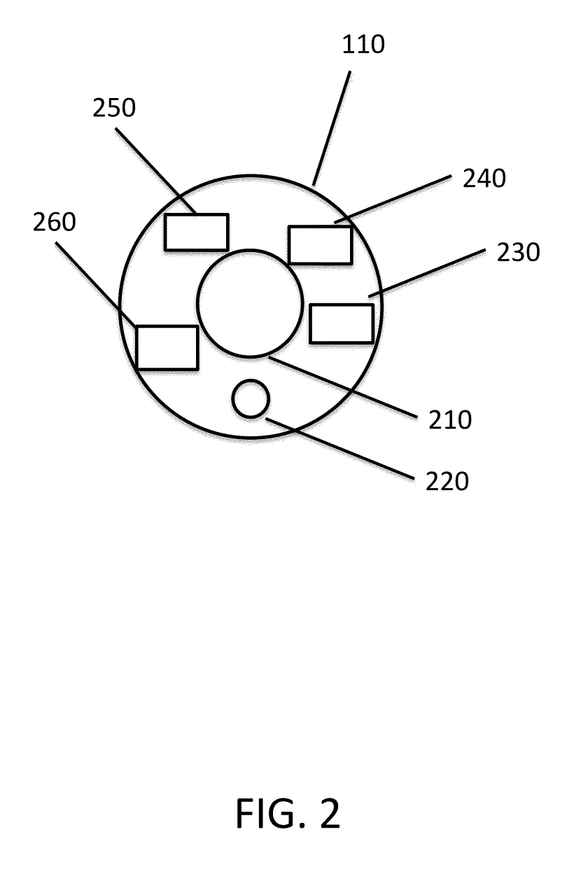

Referencing FIG. 2, the steering wheel assembly 110 consists of several components. Steering wheel 110 is connected to the base 140 with a bearing 210. The antenna 220 is used to communicate with other pieces of the system. The gyroscope component 230 determines the rotation of the steering wheel to identify the amount of right or left steering to be transmitted to the model car 150. To do that the microprocessor 240 is used to process the calculations. The radio transreceiver chip 250 is on 2.4 GHz radio frequency. To be able to operate the steering wheel 110, a rechargeable battery unit 260 is located inside the steering wheel assembly 110.

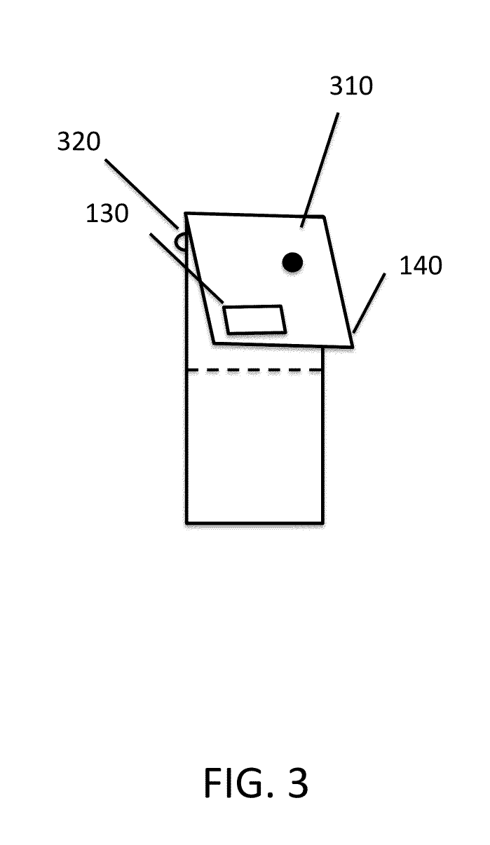

In FIG. 3, the steering wheel base 140 is provided. All of the described parts of the system can be seen on the visuals. However it should be noted that there may be other means of accomplishing the same results by using different shapes and sizes of the similar parts. The base has the screen display 130 to be able to provide information to the user. User can set up the system by using the screen display 130. The steering wheel base 140 has also steering wheel bearing base 310 to snap the steering wheel bearing 210 to the base easily. It will be an easy lock mechanism. There is a carrying hole for a strap 320 to connect a strap to the steering wheel base 140 for an ergonomic design to carry the base 140 by folding it.

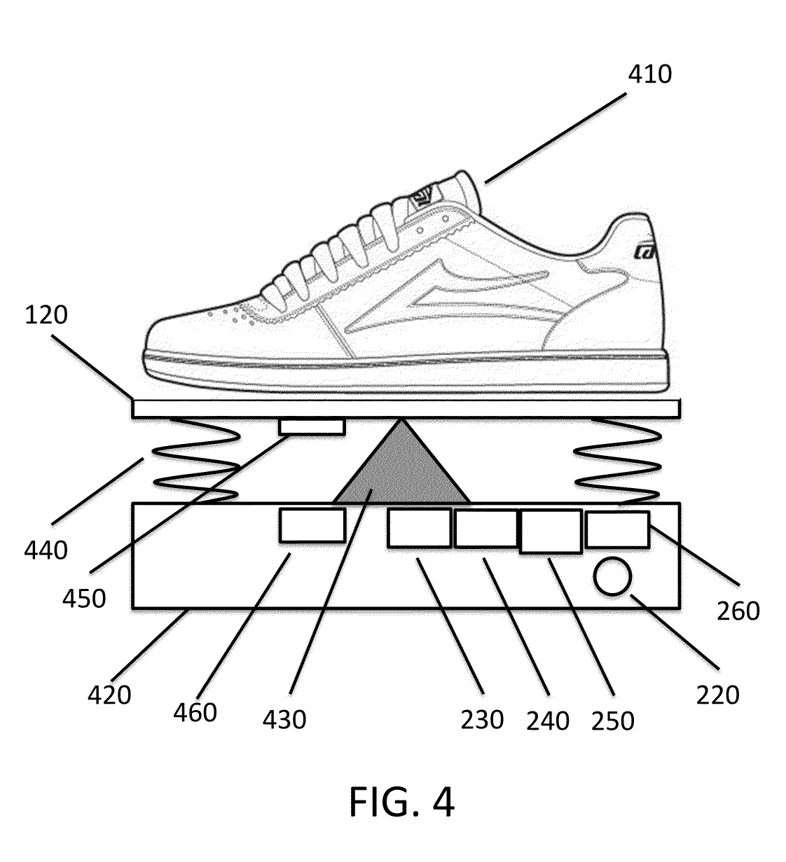

Referencing FIG. 4, it is a schematic of the pedal 120. Pedal is designed for using by foot 410. However, the user can use by hand by placing it on the steering wheel base or on the lap. The pedal 120 consists of several components. Like the other components of the system such as steering wheel 110, the pedal 120 also has antenna 220, gyroscope component 230, microprocessor 240, 2.4 GHz transreceiver 250 and rechargeable battery pack 260. The pedal 120 sits on a base 420 ideally on the ground. There is a pedal leveler 430 located on the base 420. At the back and on the front of the pedal 120, there are pedal springs 440 to balance the pedal. There are two critical components to determine how much the pedal is pushed down are the magnet 450 and the Hall effect sensor 460. The magnet 450 is located just under the pedal 120. The Hall effect sensor 460 is located on the base 420. These two components can determine the distance that the pedal 120 traveled when the user's foot 410 pushed on the pedal 120.

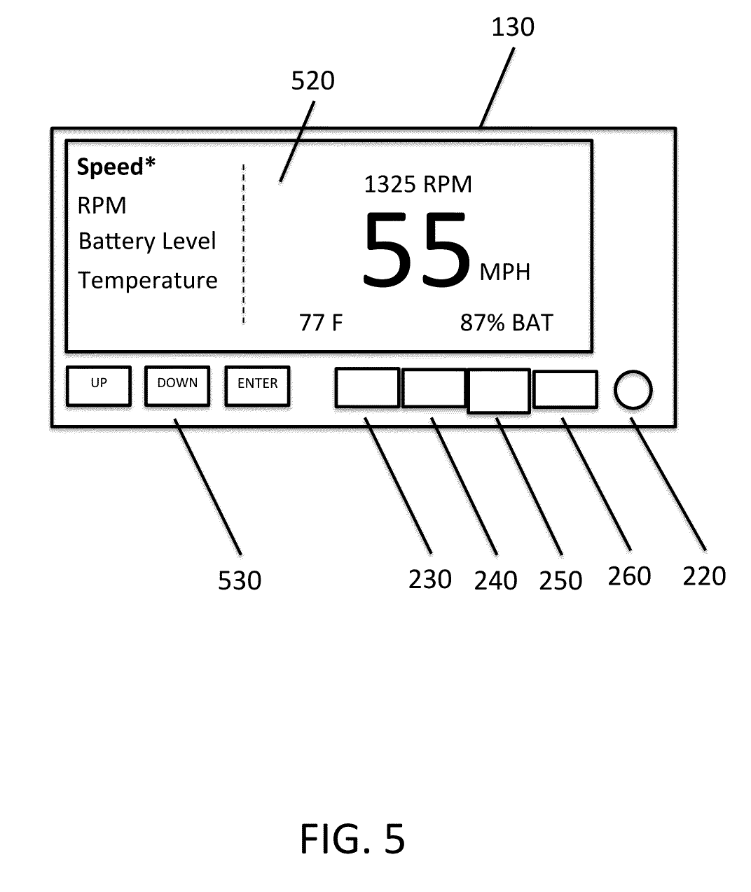

FIG. 5 is a schematic for the screen display 130. It consists of the similar radio transmitter components like the other parts of the system have. The antenna 220, gyroscope module 230, microprocessor 240, 2.4 GHz transreceiver 250 and the rechargeable battery pack 260 are located in the screen display assembly 130. The LCD screen 520 is used to communicate the information to the user and to get the directions for setup from the user. The possible information options are the speed (MPH), RPM, battery level and the temperature of the RC vehicle 150. The user can navigate by using the control buttons 530 located on the screen display assembly 130. There are several different options for designing the user screen. The embodiment shown is just a suggestion about one of the possibilities. In terms of setup features, the followings can be a list of options for the user to set:
Memory for the model of the vehicle such as RC car A, B, C . . . or RC boat A, B, C . . .
Sensitivity of the steering wheel to select between high, medium or low. This adjusts the responsiveness of the steering wheel
Battery level alerts to alert the user when the battery reaches to a certain level such as 20%
User name set up to assign certain settings to a certain user

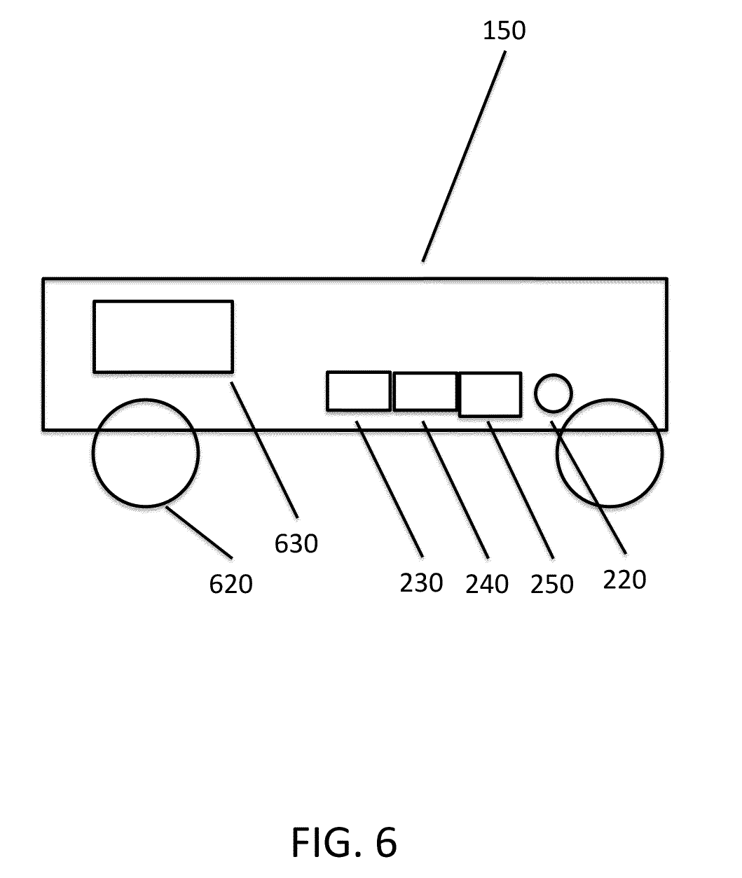

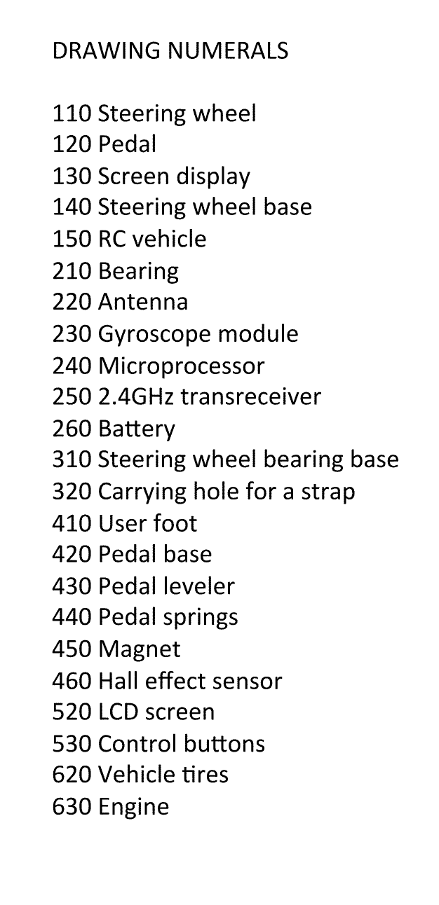

Referencing FIG. 6, it is a schematic of the RC vehicle 150. Other then the same transmitter components such as antenna 220, gyroscope module 230, microprocessor 240 and 2.4 GHz transreceiver, there are also the wheels 620 and the engine 630 parts. In case of the boat, there would be steering mechanism instead of wheels 620. The engine 630 can be electric or diesel engine depending on the type of the application.

The mentioned rechargeable battery pack can also be a regular AA or AAA type disposable batteries. The gyroscope module 230 provides stability control and the direction sensing for the RC vehicle 150. The physical orientations of the RC vehicle 150 and the radio transmitter 110 are coupled together by the gyroscopes located on both RC model vehicle and the radio transmitter to create a navigation platform. When there is a certain threshold is achieved, the RC vehicle 150 is taken under control by the microprocessor 240 and adjusted relative to the circumstances. For example, if the RC vehicle 150 makes a left turn sharply at above 35 MPH and generates rotational forces more than the set threshold, the engine 630 shuts off and the brakes applied if necessary.

What is claimed is:

1. A gyroscope based radio transmitter system for a radio controlled (RC) vehicle such as a car or a boat, which allows the user to direct the vehicle by using a more ergonomic steering wheel and a pedal. Said system can be carried easily to indoor or outdoor tracks by folding the steering wheel base and also can be used for different RC vehicles by different users. The system comprising:
A gyroscope based steering wheel
Said parts are:
Bearing to rotate the steering wheel, Antenna, Gyroscope module, Microprocessor, 2.4 GHz transreceiver, Battery
A pedal for acceleration and braking
Said parts are:
Base, Leveler, Springs, Magnet, Hall effect sensor, Antenna, Gyroscope module, Microprocessor, 2.4 GHz transreceiver, Battery
A screen display to communicate with the user
Said parts are:
LCD screen, Control buttons, Antenna, Gyroscope module, Microprocessor, 2.4 GHz transreceiver, Battery
A foldable base for the steering wheel assembly
Said parts are:
Bearing base for the steering wheel, Carrying hole, Antenna, Gyroscope module, Microprocessor, 2.4 GHz transreceiver, Battery
A transreceiver to be located on the RC vehicle
Said parts are:
Antenna, Gyroscope module, Microprocessor, 2.4 GHz transreceiver
Said RC vehicle with an engine and wheels for cars or steering mechanism for boats.

2. A gyroscope based radio transmitter system of claim 1, further comprising a user administrative system consists of an LCD screen display and user control buttons or means that allows users:
to assign certain user settings to certain users
to assign certain RC vehicles to certain users
to monitor key telemetries from the RC vehicle

3. A gyroscope based radio transmitter system of claim 1, further comprising a method for the user
to couple the physical orientations of the RC vehicle and the radio transmitter by using gyroscopes located on both system components
to alert the user with visual signs and sound then perform the stability control tasks automatically when the certain rotational forces of the RC vehicle are reached to the thresholds set by the user
to provide user a radio control design similar to real life vehicle driving experience. Radio transmitter consists of a round shaped steering wheel knob that is close to the size of a palm of a human being. The same system has a pedal to be used by the foot to simulate the real life vehicle driving experience.
to collect and analyze the usage history data by user to keep record of the usage date, time and RC vehicle telemetry data such as speed, RPM, battery level and temperature.
